(19) United States
(12) Patent Application Publication
(10) Pub. No.: US 2015/0031811 A1
(43) Pub. Date: Jan. 29, 2015

(54) POLYMER-CLAY NANOCOMPOSITE MATERIAL

(71) Applicant: KING FAHD UNIVERSITY OF PETROLEUM AND MINERALS, DHAHRAN (SA)

(72) Inventors: MOHAMMAD NAHID SIDDIQUI, DHAHRAN (SA); HALIM HAMID REDHWI, DHAHRAN (SA); DIMITRIS S. ACHILIAS, THESSALONIKI (GR)

(73) Assignee: KING FAHD UNIVERSITY OF PETROLEUM AND MINERALS, DHAHRAN (SA)

(21) Appl. No.: 13/953,706

(22) Filed: Jul. 29, 2013

(51) Int. Cl. C08K 5/544

(52) U.S. Cl. CPC C08K 5/544
USPC 524/262

(57) ABSTRACT

The polymer-clay nano composite material is a nanocomposite formed from poly(styrene-co-ethyl methacrylate) copolymer and organo-modified clay by in situ polymerization. Nanoparticles of a montmorillonite clay that has been modified with a quaternary ammonium salt are dispersed into a mixture of styrene and ethyl methacrylate monomers to form a mixture, which then undergoes bulk radical polymerization. The poly(styrene-co-ethyl methacrylate) copolymer preferably has a styrene to ethyl methacrylate ratio of about 1:1. Preferably, the organically modified montmorillonite clay forms between 1.0 wt % and 5.0 wt % of the mixture. A free radical initiator, such as benzoyl peroxide, is used to initiate polymerization. The clay nano-filler provides the nanocomposite with improved thermal stability. The poly(styrene-co-ethyl methacrylate) copolymer has the structural form:

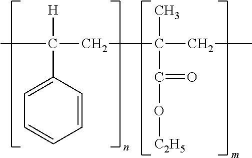

### BACKGROUND OF THE INVENTION

1. Field of the Invention

The present invention relates to nanocomposite materials, and particularly to a polymer-clay nanocomposite material that provides a nanocomposite made from poly(styrene-co-ethyl methacrylate) and organo-modified clay by in situ polymerization.

2. Description of the Related Art

Compared to conventional filled polymers, polymer/layered silicate nanocomposites have recently attracted the attention of researchers due to their unique material properties. Specifically, the addition of only a very small amount of clay (typically less than 5 wt %) to a polymeric matrix has a significant impact on the mechanical, thermal, fire and barrier properties of the polymer.

The formation of polymer-based nanocomposites has been achieved by several methods, including in situ polymerization, polymer melting, and solution intercalation/exfoliation. Among these, dispersing in situ polymerization may be the most desirable method for preparing nanocomposites, since the types of nanoparticles and the nature of polymer precursors can vary in a wide range to meet the requirements of the process. In in situ polymerization, the clay is swollen in the monomer for a certain time, depending on the polarity of the monomer molecules and the surface treatment of clay. The monomer migrates into the galleries of the layered silicate so that the polymerization reaction occurs between the intercalated sheets. Long-chain polymers within the clay galleries are thus produced.

Although such in situ techniques have been studied with respect to bulk free radical polymerization, such techniques have not been widely applied to methacrylates. Given the broad and far-ranging applications of methacrylates, it would obviously be desirable to be able to modify and improve their properties through such a process.

Thus, a polymer-clay nanocomposite material solving the aforementioned problems is desired.

### SUMMARY OF THE INVENTION

The polymer-clay nanocomposite material is a nanocomposite formed from poly(styrene-co-ethyl methacrylate) copolymer and organo-modified clay by in situ polymerization. Nanoparticles of a montmorillonite clay that has been modified with a quaternary ammonium salt are dispersed into a mixture of styrene and ethyl methacrylate monomers to form a mixture, which then undergoes bulk radical polymerization. The poly(styrene-co-ethyl methacrylate) copolymer preferably has a styrene to ethyl methacrylate ratio of about 1:1. Preferably, the organically modified montmorillonite clay forms between 1.0 wt % and 5.0 wt % of the mixture. A free radical initiator, such as benzoyl peroxide, is used to initiate polymerization. The clay nano-filler provides the nanocomposite with improved thermal stability. The poly(styrene-co-ethyl methacrylate) copolymer has the structural form:

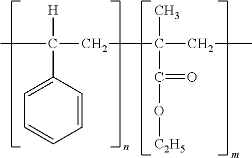

These and other features of the present invention will become readily apparent upon further review of the following specification and drawings.

### BRIEF DESCRIPTION OF THE DRAWINGS

FIG. 1 is the Fourier-transform infrared (FTIR) spectra of a polymer-clay nanocomposite material according to the present invention, compared against polystyrene (PS) and poly(ethyl methacrylate) (PEMA) homopolymers.

FIG. 2A is a portion of the Fourier-transform infrared (FTIR) spectra of a polymer-clay nanocomposite material according to the present invention, compared against polystyrene (PS) and poly(ethyl methacrylate) (PEMA) homopolymers within the wavenumber range of 3200 cm⁻¹ to 2700 cm⁻¹.

FIG. 2B is a portion of the Fourier-transform infrared (FTIR) spectra of a polymer-clay nanocomposite material according to the present invention, compared against polystyrene (PS) and poly(ethyl methacrylate) (PEMA) homopolymers within the wavenumber range of 1700 cm⁻¹ to 1400 cm⁻¹.

FIG. 2C is a portion of the Fourier-transform infrared (FTIR) spectra of a polymer-clay nanocomposite material according to the present invention, compared against polystyrene (PS) and poly(ethyl methacrylate) (PEMA) homopolymers within the wavenumber range of 2000 cm⁻¹ to 1600 cm⁻¹.

FIG. 3A is a portion of the Fourier-transform infrared (FTIR) spectra of a polymer-clay nanocomposite material according to the present invention, with concentrations of a CLOISITE® 15A organo-modified clay being shown for 1.0 wt %, 3.0 wt % and 5.0 wt %, for bulk polymerization at a constant temperature of 80° C. and an initial initiator concentration of 0.03 M benzoyl peroxide (BPO), within the wavenumber range of 4000 cm⁻¹ to 500 cm⁻¹.

FIG. 3B is a portion of the Fourier-transform infrared (FTIR) spectra of a polymer-clay nanocomposite material according to the present invention, with concentrations of a CLOISITE® 15A organo-modified clay being shown for 1.0 wt %, 3.0 wt % and 5.0 wt %, obtained from bulk polymerization at a constant temperature of 80° C. and an initial initiator concentration of 0.03 M benzoyl peroxide (BPO), within the wavenumber range of 600 cm⁻¹ to 440 cm⁻¹.

FIG. 4A is the X-ray diffraction (XRD) spectra of a polymer-clay nanocomposite material according to the present invention, with concentrations of a CLOISITE® 10A organo-modified clay being shown for 1.0 wt %, 3.0 wt % and 5.0 wt %, obtained from bulk polymerization at a constant temperature of 80° C. and an initial initiator concentration of 0.03 M benzoyl peroxide (BPO).

FIG. 4B is the X-ray diffraction (XRD) spectra of a polymer-clay nanocomposite material according to the present invention, with concentrations of a CLOISITE® 15A organo-modified clay being shown for 1.0 wt %, 3.0 wt % and 5.0 wt %, obtained from bulk polymerization at a constant temperature of 80° C. and an initial initiator concentration of 0.03 M benzoyl peroxide (BPO).

FIG. 5 is a graph illustrating percent conversion vs. time curves for polystyrene, pure poly(ethyl methacrylate), and poly(styrene-co-ethyl methacrylate) copolymers according to the present invention obtained from bulk polymerization at a constant temperature of 80° C. and an initial initiator concentration of 0.03 M benzoyl peroxide (BPO).

FIG. 6A is a graph illustrating percent conversion vs. time curves for a polymer-clay nanocomposite material according to the present invention, with concentrations of a CLOISITE® 15A organo-modified clay being shown for 1.0 wt %, 3.0 wt % and 5.0 wt %, obtained from bulk polymerization at a constant temperature of 80° C. and an initial initiator concentration of 0.03 M benzoyl peroxide (BPO).

FIG. 6B is a graph illustrating percent conversion vs. time curves for a polymer-clay nanocomposite material according to the present invention, with concentrations of a CLOISITE® 10A organo-modified clay being shown for 1.0 wt %, 3.0 wt % and 5.0 wt %, obtained from bulk polymerization at a constant temperature of 80° C. and an initial initiator concentration of 0.03 M benzoyl peroxide (BPO).

FIG. 7A is a graph illustrating molecular weight distribution curves for a polymer-clay nanocomposite material according to the present invention, with concentrations of a CLOISITE® 15A organo-modified clay being shown for 1.0 wt %, 3.0 wt % and 5.0 wt %, obtained from bulk polymerization at a constant temperature of 80° C. and an initial initiator concentration of 0.03 M benzoyl peroxide (BPO).

FIG. 7B is a graph illustrating molecular weight distribution curves for a polymer-clay nanocomposite material according to the present invention, with concentrations of a CLOISITE® 10A organo-modified clay being shown for 1.0 wt %, 3.0 wt % and 5.0 wt %, obtained from bulk polymerization at a constant temperature of 80° C. and an initial initiator concentration of 0.03 M benzoyl peroxide (BPO).

FIG. 8A is a graph illustrating differential variation of molecular weight distribution curves for a polymer-clay nanocomposite material according to the present invention, with a concentrations of a CLOISITE® 15A organo-modified clay of 3.0 wt %.

FIG. 8B is a graph illustrating average molecular weights for a polymer-clay nanocomposite material according to the present invention, with a concentrations of a CLOISITE® 15A organo-modified clay of 3.0 wt %.

FIG. 9 is a graph illustrating differential scanning calorimetry (DSC) curves for a polymer-clay nanocomposite material according to the present invention, with concentrations of a CLOISITE® 15A organo-modified clay being shown for 1.0 wt %, 3.0 wt % and 5.0 wt %.

FIG. 10 is a graph comparing mass loss curves as a function of temperature for polymer-clay nanocomposite materials according to the present invention with CLOISITE® Na⁺, CLOISITE® 15A and CLOISITE® 10A organo-modified clays.

FIG. 11A is a graph illustrating percent mass loss as a function of temperature for a polymer-clay nanocomposite material according to the present invention, with concentrations of a CLOISITE® 15A organo-modified clay being shown for 1.0 wt %, 3.0 wt % and 5.0 wt %.

FIG. 11B is a graph illustrating differential thermogravimetric analysis (DTGA) for a polymer-clay nanocomposite material according to the present invention, with concentrations of a CLOISITE® 15A organo-modified clay being shown for 1.0 wt %, 3.0 wt % and 5.0 wt % at a heating rate of 10° C./min.

FIG. 12A is a graph illustrating percent mass loss as a function of temperature for a polymer-clay nanocomposite material according to the present invention, with concentrations of a CLOISITE® 10A organo-modified clay being shown for 1.0 wt %, 3.0 wt % and 5.0 wt %.

FIG. 12B is a graph illustrating differential thermogravimetric analysis (DTGA) for a polymer-clay nanocomposite material according to the present invention, with concentrations of a CLOISITE® 10A organo-modified clay being shown for 1.0 wt %, 3.0 wt % and 5.0 wt % at a heating rate of 10° C./min.

Similar reference characters denote corresponding features consistently throughout the attached drawings.

### DETAILED DESCRIPTION OF THE PREFERRED EMBODIMENTS

The polymer-clay nanocomposite material is a nanocomposite formed from poly(styrene-co-ethyl methacrylate) copolymer and organo-modified clay by in situ polymerization. Nanoparticles of a montmorillonite clay that has been modified with a quaternary ammonium salt are dispersed into a mixture of styrene and ethyl methacrylate monomers to form a mixture, which then undergoes bulk radical polymerization. The poly(styrene-co-ethyl methacrylate) copolymer preferably has a styrene to ethyl methacrylate ratio of about 1:1. Preferably, the organically modified montmorillonite clay forms between 1.0 wt % and 5.0 wt % of the mixture. A free radical initiator, such as benzoyl peroxide, is used to initiate polymerization. The clay nano-filler provides the nanocomposite with improved thermal stability. The poly(styrene-co-ethyl methacrylate) copolymer has the structural form:

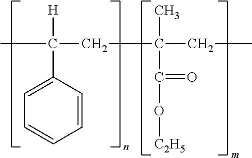

Initially, a monomer mixture of styrene with EMA was prepared by mixing equal amounts of the two monomers. Organo-montmorillonite (OMMT) was then added to 25 g of the monomer mixture. The OMMT was dispersed in the monomer mixture within a 100 mL conical flask by magnetic and ultrasonic agitation. The magnetic agitation was performed for 24 hours, and the supersonic agitation was performed for one hour for each prepared sample. The dispersion of the particles in the monomer mixture was homogeneous, as indicated by a high translucency in the visible region. In the final suspension, 0.03 M benzoyl peroxide (BPO) was added as a free radical initiator, and the mixture was degassed by nitrogen passing.

Two series of the polymer-clay nanocomposites were prepared by in situ free radical bulk polymerization. In the first series, CLOISITE® 15A, an organically-modified montmorillonite clay manufactured by Southern Clay Products, Inc. of Gonzales, Tex. was used in differing relative amounts of 1.0, 3.0 and 5.0 wt %, compared to the monomer mixture. In the second series, the type of the nano-clay used was CLOISITE® 10A, again at relative amounts of 1.0, 3.0 and 5.0 wt % compared to the monomer mixture. The organic modifier in CLOISITE® 15A is a quaternary ammonium salt, viz., a dimethyl, dihydrogenated tallow quaternary ammonium salt, and the organic modifier in CLOISITE® 10A is also a quaternary ammonium salt, viz., a dimethyl, benzyl, hydrogenated tallow quaternary ammonium salt.

In order to study the reaction kinetics, free radical bulk polymerization was carried out in small test-tubes by heating the initial monomer-nanoclay-initiator mixture at 80° C. About 2 mL of the pre-weighted mixtures of monomer with the initiator and each type of CLOISITE® were placed into a series of ten small test tubes. After degassing with nitrogen, these were sealed and placed into a pre-heated bath at 80° C. Each test tube was removed from the bath at pre-specified time intervals and was immediately frozen after the addition of a few drops of hydroquinone in order to stop the reaction. The product was then isolated after dissolving in CH₂Cl₂ and re-precipitating (recrystallizing) in methanol. A different procedure for the nanocomposite isolation was followed in the last two or three samples of each experiment. Since the reaction was already finished, and the polymer/nanofiller mixture was a solid, the test tubes were broken and the products were obtained as such. In this way, it was ensured that the filler was enclosed into the polymer matrix. Subsequently, all isolated materials were dried to constant weight in a vacuum oven at room temperature. All final samples were weighed and the degree of conversion was estimated gravimetrically.

In order to examine the resultant products, X-ray diffraction (XRD), Fourier-transform infrared (FTIR), differential scanning calorimetry (DSC), gel permeation chromatography (GPC), and thermogravimetric analysis (TGA) were all used. X-ray diffraction patterns were obtained using an X-ray diffractometer equipped with a CuKa generator (λ=0.1540 nm). Scans were taken in the range of diffraction angle 2θ=1-10°.

The chemical structure of the copolymer-based nanocomposites and the two different types of CLOISITE® were confirmed by recording their infrared (IR) spectra. The FTIR resolution used was 4 cm⁻¹. The recorded wavenumber range was from 4000 to 400 cm⁻¹, and 32 scans were averaged to reduce noise. Thin films were used in each measurement, formed by a hydraulic press.

In order to estimate the glass transition temperature of each nanocomposite prepared, DSC was used. About 10 mg of each sample was weighed, put into a standard sample pan, sealed, and placed in the appropriate position of the calorimeter. Subsequently, the samples were heated to 180° C. at a rate of 10° C. per minute to ensure complete polymerization of the residual monomer. Following this, the samples were cooled to 0° C., and their glass transition temperature was measured by heating again to 180° C. at a rate of 20° C. per minute.

The molecular weight distribution (MWD) and the average molecular weights of the pure copolymers and all nanocomposites were determined by GPC. The gel permeation chromatograph included an isocratic pump, a differential refractive index detector, and three PLgel 5μ MIXED-C columns in series. All samples were dissolved in tetrahydrofuran (THF) at a constant concentration of 1 mg per mL. After filtration, 200 μL of each sample was injected into the chromatograph. The elution solvent was THF at a constant flow rate of 1 mL per minute, and the entire system was kept at a constant temperature of 30° C.

The thermal stability of the samples was measured by thermogravimetric analysis. Samples of about 5 to 8 mg were used. The samples were heated from ambient temperature to 600° C. at a heating rate of 10° C. per minute under nitrogen flow, while the samples of clay were heated up to 800° C. Table 1 below shows the chemical structure of the organic modifiers of the different types of CLOISITE® used, together with their cation exchange capacity (CEC) and the d₀₀₁ spacing measured from XRD.

TABLE 1
Chemical Structure of the Organic Modifiers of Cloisite Samples

| | | CEC | | | d₀₀₁ (Å) |
|---|---|---|---|---|---|
| | | (meq/100 | 2θ | d₀₀₁ (Å) | (from |
| Sample | Organic modifier | g clay) | (°) | measured | supplier) |
| Cloisite ® | None | 92 | 7.46 | 11.8 | 11.7 |
| Na⁺ | | | | | |
| Cloisite ® 10A | 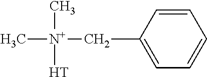 | 125 | 4.77 | 18.5 | 19.2 |
| Cloisite ® 15A | 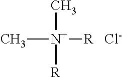 | 125 | 2.96 | 29.8 | 31.5 |

where R and HT are hydrogenated tallow (˜65% C18, ˜30% C16, ˜5% C14).

Fourier transform infrared spectroscopy was used for the structural characterization of the polymer-clay (P(S-co-EMA)) copolymer and its nanocomposites. Initially, the formation of copolymers was verified and, subsequently, the presence of the OMMT in the copolymer matrix was identified. IR spectra of neat polystyrene (PS) and poly(ethyl methacrylate) (PEMA) homopolymers compared against that of the P(S-co-EMA) copolymer are shown in FIG. 1. The presence of some common peaks due to the alkyl groups between 2900 cm⁻¹ and 3000 cm⁻¹ can be seen in FIG. 1, Asymmetric C—H stretching vibrations of the methyl groups gives a peak at 2981 cm⁻¹. The symmetric stretching vibrations of the —CH₃ group appear to overlap with the stretching vibrations of the —CH₂ group in the region of 2952-2862 cm⁻¹. The absorption band in the 1730-1720 cm⁻¹ region with a peak at about 1724 cm⁻¹ is characteristic of the ester carbonyl —C═O stretching vibrations, and a weak peak for the overtone of the carbonyl stretching band. The peak at 1638 cm⁻¹ is attributed to C═C double bond stretching, which exists only in the PEMA, and the C—H bonding due to the C═CH₂ group appears at 939 cm⁻¹. These peaks are very small and may be due to the fact that some disproportion occurs in the termination process. The skeletal vibrations of the polymer backbone, and the —C—O—C— stretching resonances, appear to be broad in the regions of 1141-1148 cm⁻¹ and 1100-1280 cm⁻¹, respectively. The IR spectra also show the characteristic absorption bands of a phenyl ring in the styrene. The polystyrene spectrum has dominant peaks at 2850 and 2924 cm⁻¹ from the methylene stretches. The out-of-plane —C—H deformation vibrations of the aromatic ring hydrogens are found by noticing two sharp signals at 757 and 700 cm⁻¹. The aromatic ring breathing modes appear at 1601, 1493 and 1452 cm⁻¹. The peaks at 3082, 3061 and 3027 cm⁻¹ are assigned to —C—H stretching vibrations of ring hydrogens, and the overtone and combination bands of —C—H deformation vibrations are found in the region 1660-2000 cm⁻¹.

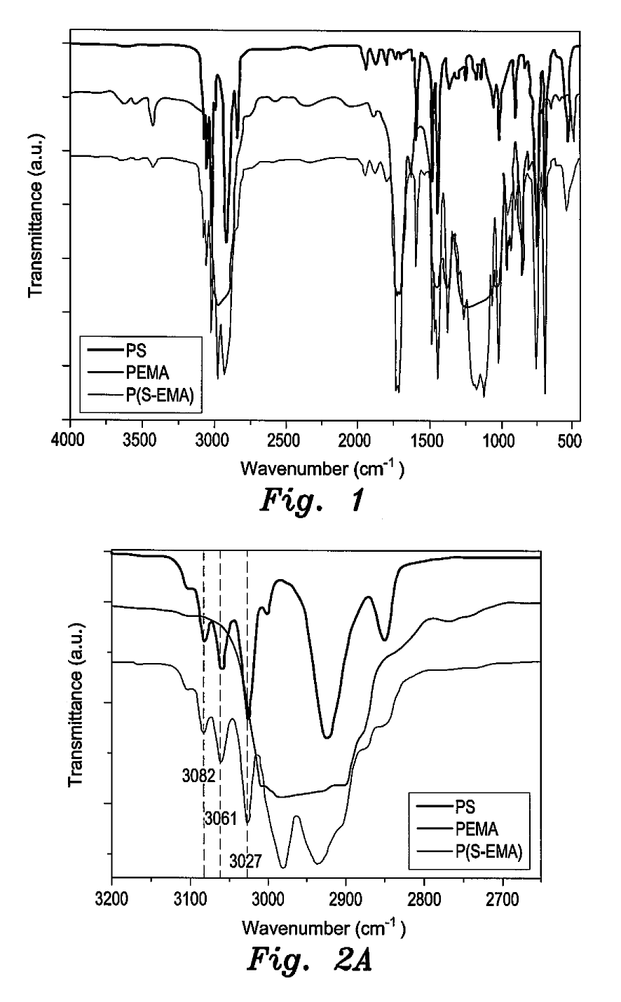

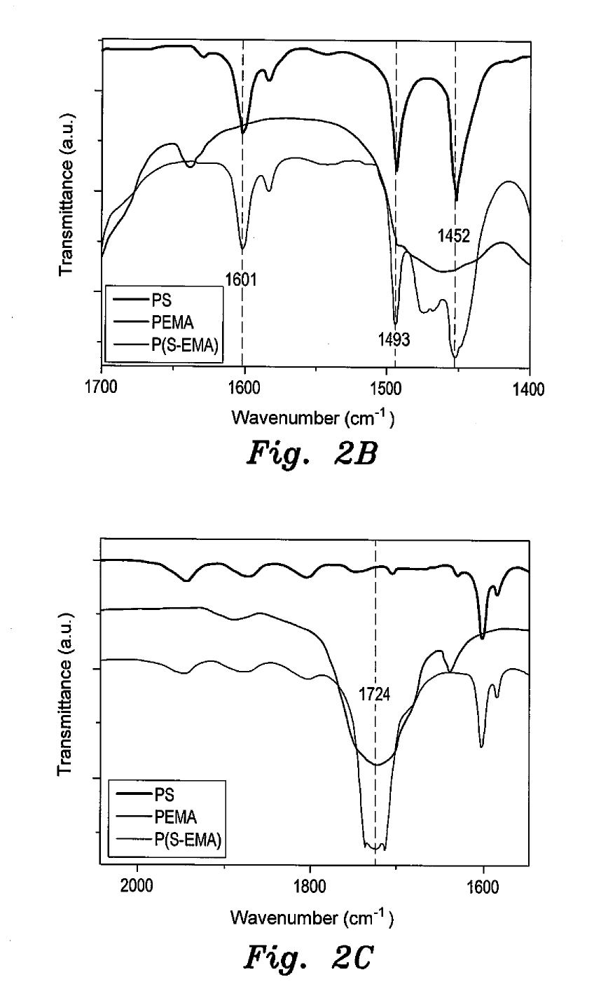

In order to verify the formation of copolymers, certain parts of the spectra were isolated and presented in FIGS. 2A, 2B and 2C. Thus, the characteristic peaks of PS at 3082, 3061 and 3027 cm⁻¹ (FIG. 2A) together with those at 1601, 1493 and 1452 cm⁻¹ (FIG. 2B) appear clear in both PS and the copolymer, verifying the presence of styrene in the copolymer matrix. Moreover, the existence of EMA was verified by isolating the characteristic sharp peak at 1724 cm⁻¹ appearing in both PEMA and the copolymer (FIG. 2C).

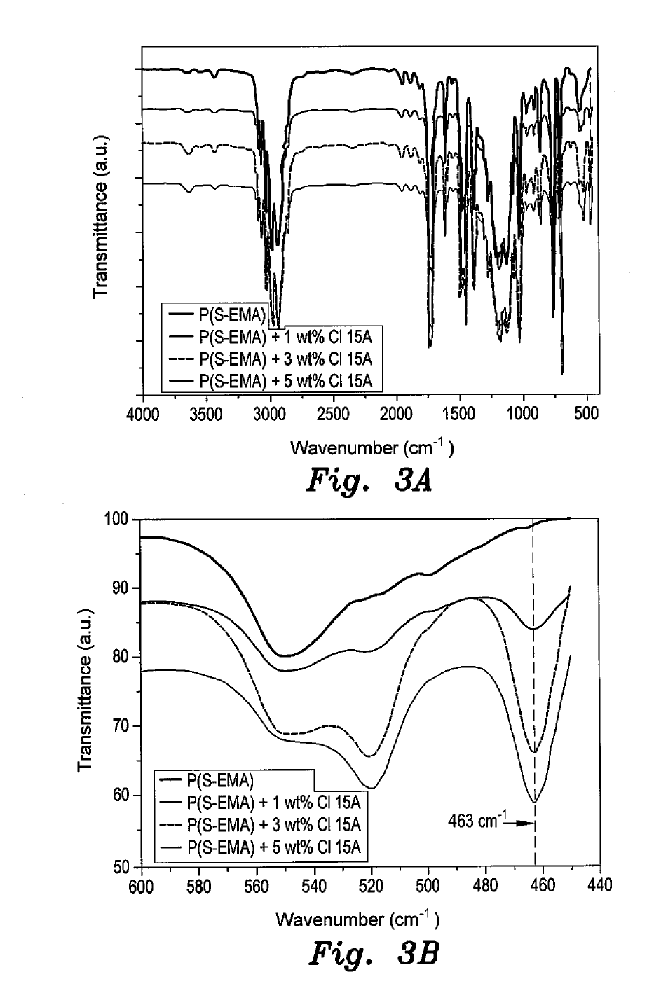

Further, the IR spectra of the neat copolymer and its nanocomposites were studied to evaluate the interaction between the nanoclay and the polymer matrix (FIGS. 3A and 3B). Through this, the affirmation of a nanoclay effect on the polymerization kinetics could also be investigated. In both types of CLOISITE® and at all relative amounts, no significant difference in the peaks was observed. Therefore, it could be concluded that the OMMT is physically dispersed in the monomer mixture without forming any chemical bonding. Further, the characteristic wavenumber of the Al—O bond in OMMT appears at 463 cm⁻¹. This peak is clear in all nanocomposites and increases in intensity with the amount of the nano-filler, while being completely absent in the neat copolymer (FIG. 3B).

The type of nanocomposite formed was checked with XRD. Polymer-clay nanocomposites can be characterized as immiscible (tactoids), intercalated, partially exfoliated or exfoliated. The particular form depends on the clay content, the chemical nature of the organic modifier, and the synthetic method. In general, an exfoliated system is more feasible with lower clay content (about 1 wt %), while an intercalated structure is frequently observed for nanocomposites with higher clay content.

From XRD measurements, the d-spacing for CLOISITE® Na⁺, CLOISITE® 15A and CLOISITE® 10A were measured as 1.18, 2.98 and 1.85 nm, as shown above in Table 1, which are close to the values reported by the manufacturer. The d-spacing for CLOISITE® 15A and 10A are larger than that of CLOISITE® Na⁺, indicating that the intercalant definitely intercalates into the silicate layer of MMT.

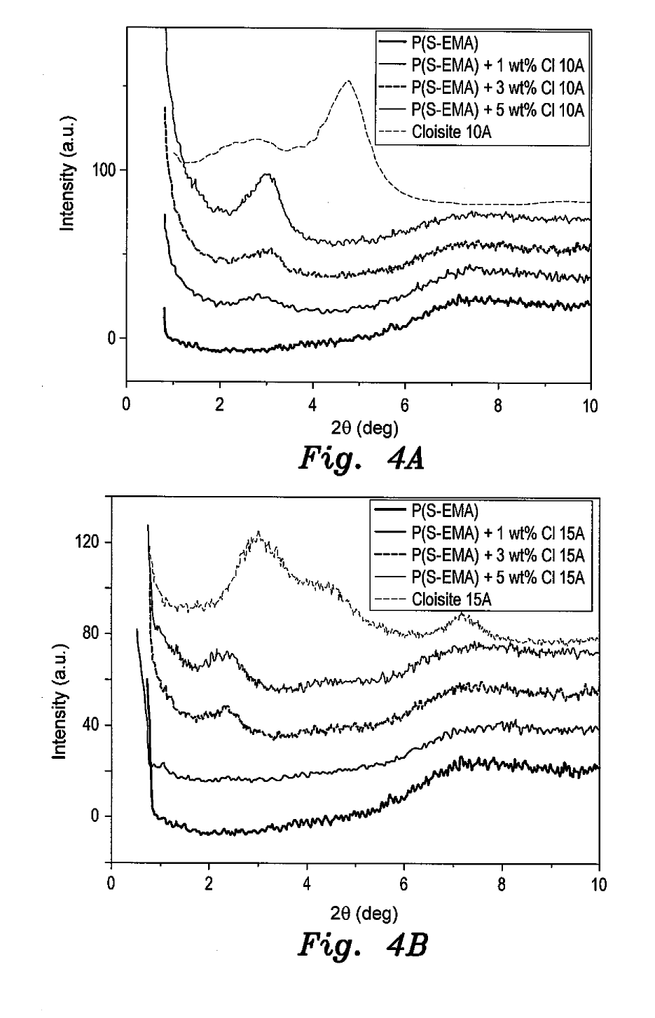

The XRD diffractograms of pure P(S-EMA) and the nanocomposites with 1, 3 and 5 wt % CLOISITE® 10A, or 1, 3 and 5 wt % CLOISITE® 15A, are shown in FIGS. 4A and 4B, respectively. No significant peak was observed for pure P(S-EMA) or the nanocomposite with 1 wt % CLOISITE® 15A. The non-existence of peaks in the XRD diffractograms suggests that the polymer/clay nanocomposites have an exfoliated morphology. As the amount of the OMMT increases to 3 or 5 wt %, the strong (001) plane peak corresponding to d₀₀₁ was clearly observed with increased peak intensity. The d₀₀₁-spacings of the nanocomposites with CLOISITE® 15A were 3.8 and 3.7 nm for compositions 3 and 5 wt %, respectively. Moreover, peaks with intensity increasing with the amount of nanofiller were observed when CLOISITE® 10A was used. The d₀₀₁-spacings of the nanocomposites were 3.15, 2.94 and 2.9 nm for compositions of 1, 3 and 5 wt %, respectively. No significant trend of the change in d-spacing was observed as a function of loading. The indexing of the d₀₀₁ peak in the diffractograms suggests that the morphology of the polymer/clay nanocomposites is intercalated. Therefore, a general conclusion from the XRD patterns is that the nanocomposites with 1 wt % nano-filler CLOISITE® 15A are rather exfoliated, while those with higher than 1 wt % OMMT, and all percentages with CLOISITE® 10A, could be considered as partially exfoliated and intercalated.

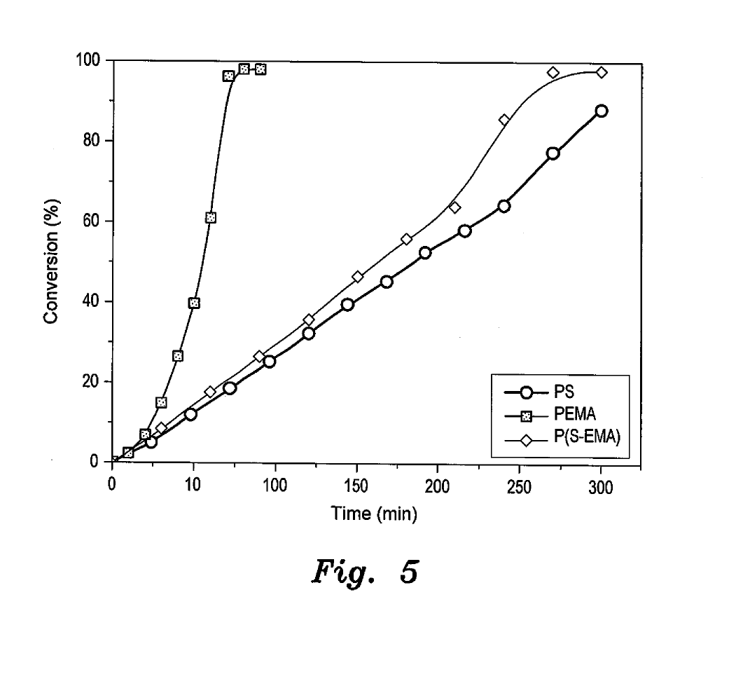

The evolution of conversion with time of the copolymer P(S-EMA) is compared to those of the corresponding two homo-polymers (i.e., polystyrene and polyethyl methacrylate)), as shown in FIG. 5. From an inspection of the curves, it is clear that PEMA exhibits a behavior typical of poly(alkyl methacrylates) with a strong gel-effect starting at low conversions (i.e., less than 20%). In the first stage of polymerization (low conversions), the conversion vs. time curve follows classical free-radical kinetics. An almost linear dependence of conversion X (or of −ln(1−X) vs. time) appears, which indicates purely chemical control of the polymerization. After a certain point of conversion, an increase in the reaction rate takes place, followed by an increase in the conversion values. This is the well-known auto-acceleration or gel-effect and is attributed to the effect of diffusion-controlled phenomena on the termination reaction and the reduced mobility of live macro-radicals in order to find one another and react. Therefore, their concentration increases locally, leading to increased reaction rates. After this, the reaction rate falls significantly and the curvature of the conversion versus time changes.

At this conversion interval, the observed decrease in the termination reaction rate is only gradual. At this stage, the center-of-mass motion of radical chains becomes very slow and any movement of the growing radical site is attributed to the addition of monomer molecules at the chain end. This additional diffusion mechanism is the so-called “reaction diffusion”. The higher the propagation reaction rate value, the more likely is reaction-diffusion to be rate-determining. Finally, at very high conversions (beyond 90%), the reaction rate tends asymptotically to zero and the reaction almost stops before the full consumption of the monomer, thus a glassy state appears, corresponding to the well-known glass-effect. This is attributed to the effect of diffusion-controlled phenomena on the propagation reaction and the reduced mobility of monomer molecules to find a macro-radical and react.

In contrast to PEMA, PS presents kinetics that are mainly kinetically controlled with a slight effect of diffusion-controlled phenomena only at high degrees of conversion. The reaction curve of the P(S-EMA) copolymer more closely resembles that of PS. Thus, the copolymer initially presents a behavior obeying classical kinetics until almost 60% conversion. After this point, an increase in the conversion time curve, characteristic of the auto-acceleration, due to the effect of diffusion-controlled phenomena on the termination reaction, appears. The effect of diffusion-controlled phenomena on the propagation reaction results in final conversion values of less than 100%.

The presence of nanoparticles may influence polymerization kinetics, especially in monomers exhibiting strong effects of diffusion phenomena on the reaction kinetics. These results are attributed to the decreased free-volume of the reacting mixture, as well as the restriction imposed in the diffusion of macro-radicals in space due to the existence of the organic modifiers in the MMT platelets, which consist of large molecules (as seen in Table 1). Therefore, the OMMT platelets with large chemical structures of the modifiers add an extra hindrance in the movement of the macro-radicals in space in order to find one another and react (i.e., terminate), resulting in locally increased radical concentrations. Thus, the presence of OMMT nanoparticles seems to enhance the polymerization rate and slightly shorten the polymerization time to achieve a specific monomer conversion. Further, using a high amount of OMMT (i.e., 5 wt %) it was observed that the ultimate conversion was near 91-92 wt % lower than that of pure PMMA (i.e., 96-97 wt %). This may be attributed to the hindered movement of the small monomer molecules to find a macroradical and react due to the high amount of nano-filler at high monomer conversions. Thus, larger amounts of monomer molecules remain unreacted.

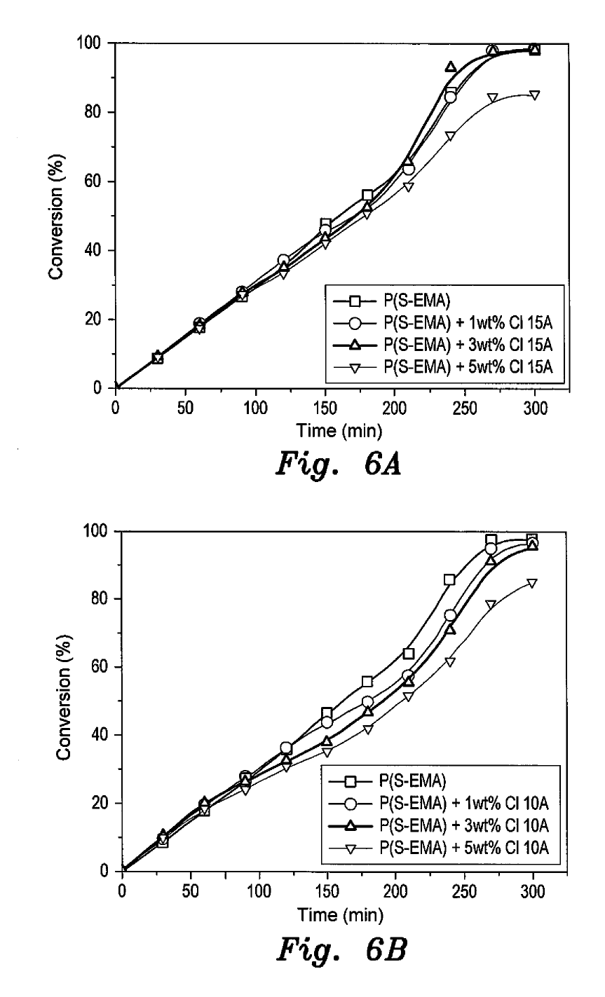

FIGS. 6A and 6B show the conversion versus time curves for P(S-EMA)-based nanocomposites with different amounts of CLOISITE® 10A (FIG. 6A) or CLOISITE® 15A (FIG. 6B). Very good reproducibility was observed in all conversion ranges (within ±1%). From an examination of the curves, the typical behavior (as in pure PEMA) was observed in almost all trials. In the first stage of polymerization (low conversions), the conversion vs. time curve, as well as polymerization rate (Rp) versus time t, follows the classical free-radical kinetics. An almost linear dependence of conversion X appears, which denotes purely chemical control of the polymerization. After a certain point (in the vicinity of 60% conversion), an increase in the reaction rate takes place, followed by an increase in the conversion values. This is the well-known auto-acceleration, or gel-effect, and is attributed to the effect of diffusion-controlled phenomena on the termination reaction and the reduced mobility of live macro-radicals in order to find one another and react. Thus, their concentration increases locally, leading to increased reaction rates.

After this point, the reaction rate falls significantly and the curvature of the conversion versus time changes. At this conversion interval (from approximately 60% to 90%), the observed decrease in the termination reaction rate is only gradual. At this stage, the center-of-mass motion of radical chains becomes very slow and any movement of the growing radical site is attributed to the addition of monomer molecules at the chain end. This additional diffusion mechanism is the so-called “reaction diffusion”. The higher the propagation reaction rate value, the more likely is reaction-diffusion to be rate determining. Finally, at very high conversions (beyond 90%), the reaction rate tends asymptotically to zero and the reaction almost stops before the full consumption of the monomer, corresponding to the well-known glass-effect. This is attributed to the effect of diffusion-controlled phenomena on the propagation reaction and the reduced mobility of monomer molecules to find a macro-radical and react.

FIGS. 6A and 6B indicate that the addition of 1 or 3 wt % CLOISITE® 15A does not affect the conversion vs. time curves. However, an increase in the amount of the nano-filler to 5 wt % appears to slightly retard the reaction, leading to decreased conversion values, especially at high degrees of conversion. This is more pronounced when CLOISITE® 10A is used, where the retardation in the reaction rate was observed at all of the differing amounts of the nano-filler. This can be attributed to the hindered movement of the small monomer molecules to find a macroradical and react, due to the high amount of nano-filler and polymer chains at high monomer conversions. Therefore, larger amounts of monomer molecules remain unreacted. CLOISITE® 10A employs a rigid phenyl ring in the organic modifier and contributes to a larger hindrance in the monomer movement. Additionally, this effect may also at least partially be due to the MMT acting as a radical scavenger. The CLOISITE® 15A appears to be the more effective nano-filler for this copolymer.

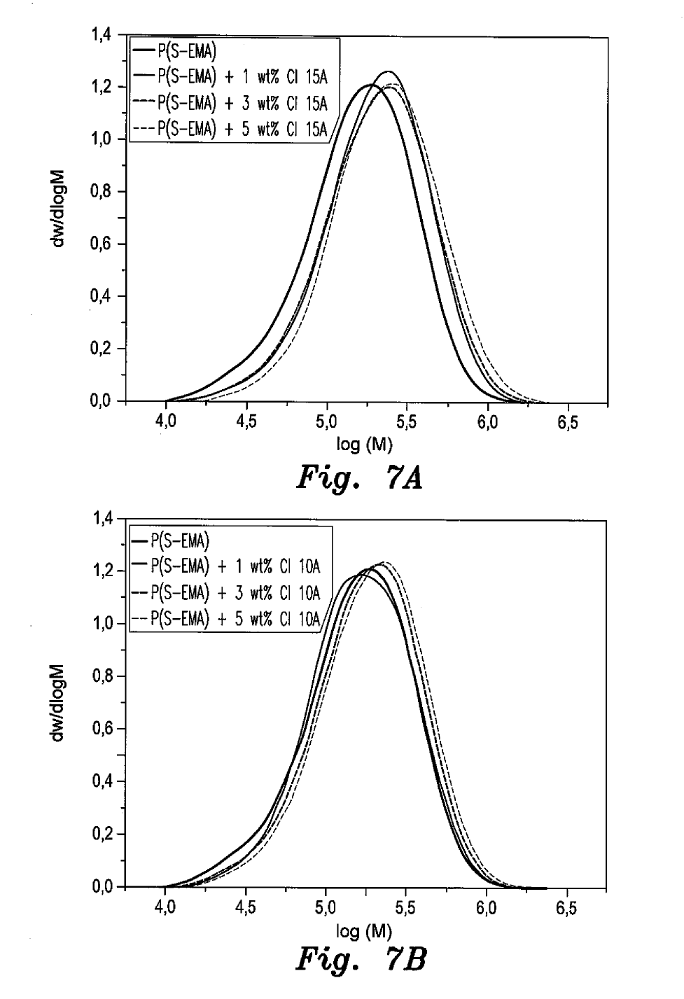

The full MWD of each sample was measured, and the results are shown in FIGS. 7A and 7B. Additionally, the number and weight average molecular weight ( M̅_{N} and M̅_{W}), as well as the polydispersity index of pure copolymer and all nanocomposites, are given below in Table 2. As shown, all of the material based on P(S-EMA) had a GPC elution pattern characteristic of a monomodal distribution. As is well-known, polymers based on PS exhibit a monomodal MWD with a polydispersity index characteristic of termination by combination (i.e., in the vicinity of 1.5), while methacrylates typically exhibit bimodal distribution with a polydispersity greater than two. The particular nano-hybrids and neat copolymer exhibit a behavior resembling that of PS (which was also observed from the kinetic conversion measurements). This was further verified by the rather low measured polydispersity indices (in the vicinity of, or less than, 2), as shown below in Table 2. Further, the MWDs of the nanocomposites with CLOISITE® 15A were shifted to higher molecular weights, compared to the pristine copolymer, while approximately similar values were measured when CLOISITE® 10A was used. The shifting of the MWDs to higher values is attributed to the formation of longer macromolecular chains during polymerization due to the existence of the nano-filler.

TABLE 2
Characteristics as Affected by Nanocomposite Composition

| Sample | M̅_{N} | M̅_{W} | PD |
|---|---|---|---|
| P(S-EMA) | 122600 | 225600 | 1.84 |
| P(S-EMA) + 1 wt % CLOISITE ® 10A | 124050 | 215800 | 1.74 |
| P(S-EMA) + 3 wt % CLOISITE ® 10A | 130400 | 229900 | 1.76 |
| P(S-EMA) + 5 wt % CLOISITE ® 10A | 143300 | 248300 | 1.73 |
| P(S-EMA) + 1 wt % CLOISITE ® 15A | 147200 | 257800 | 1.75 |
| P(S-EMA) + 3 wt % CLOISITE ® 15A | 147500 | 267800 | 1.82 |
| P(S-EMA) + 5 wt % CLOISITE ® 15A | 170700 | 300200 | 1.76 |

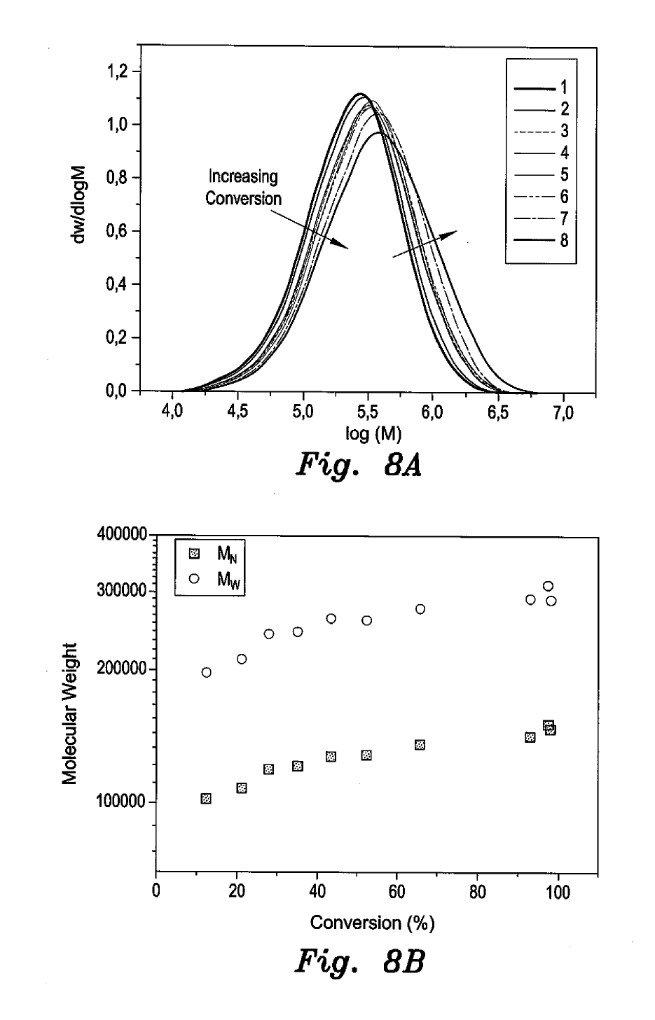

Additionally, the variation of the MWD and the molecular weight averages with conversion were also examined. The results for the nanocomposite with 3 wt % CLOISITE® 15A are shown in FIGS. 8A and 8B. A smooth increase in the molecular weight values is observed as polymerization proceeds. This behavior was also observed in a classical free-radical polymerization reaction with a mild effect of diffusion controlled phenomena on the reaction mechanism. Thus, the presence of the nano-filler does not significantly alter the polymerization behavior, either in the conversion variation or in the molecular weight development.

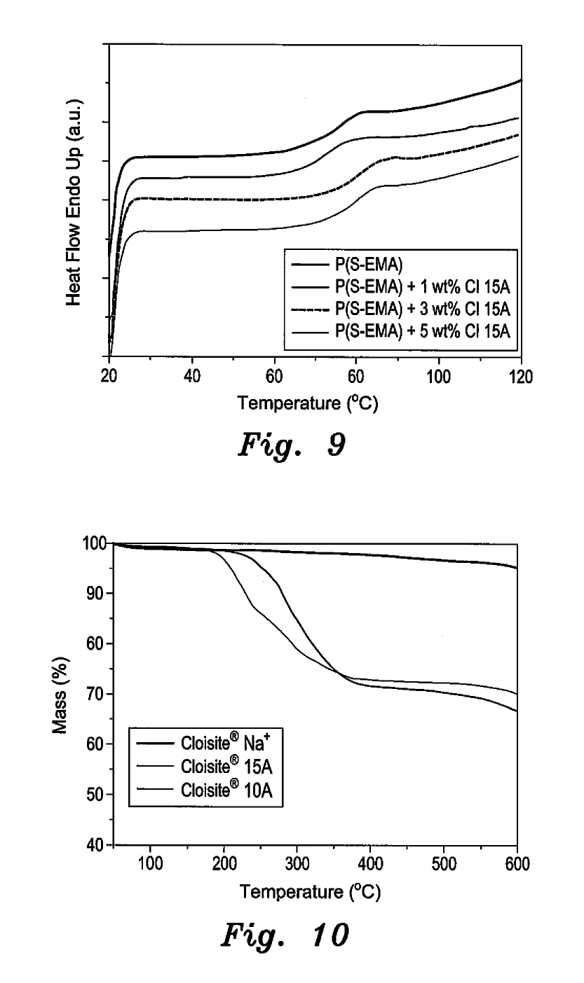

The glass transition temperature of the final sample of P(S-EMA) and all nanocomposites was measured using DSC. Indicative results of the amount of heat flow versus temperature obtained for neat P(S-EMA) and the nanocomposites with differing amounts of significantly 15A are shown in FIG. 9. Tg was estimated using the half Cp extrapolation method. No DSC artefacts were observed and the results were reproducible. All of the Tg values are shown below in Table 3. The value measured for pristine P(S-EMA) was 72.8° C. higher than that of neat PEMA (i.e., 52.5° C.) and lower than that of PS (i.e., 98° C.). The value measured for the copolymer is very close to that estimated if one uses the Gibbs-Di Marzio or Fox equations for predicting the copolymer Tg from the corresponding two homopolymers' Tg. Using the aforementioned values for PS and PEMA, the copolymer Tg is estimated to be 73.7° C. Additionally, all nanocomposites with CLOISITE® 10A exhibit similar Tg values. However, the values measured for P(S-EMA) with either 3 or 5 wt % CLOISITE® 15A were higher when compared to the pristine copolymer. This may be due to an increased segmental chain mobility of the final hybrid copolymer caused by the presence of the clay.

TABLE 3
Glass transition temperature from DSC and peak degradation temperature
and residual amount at 600° C. from TGA measurements of neat
P(S-EMA) and its nanocomposites with differing types and
amounts of OMMT

| Sample | Tg (° C.) | Tp (° C.) | Residual at 600° C. |
|---|---|---|---|
| P(S-co-EMA) | 72.8 | 421 | 0.4 |
| P(S-co-EMA) + 1 wt % | 71.9 | 445 | 0.9 |
| CLOISITE ® 10A | | | |
| P(S-co-EMA) + 3 wt % | 72.1 | 453 | 2.7 |
| CLOISITE ® 10A | | | |
| P(S-co-EMA) + 5 wt % | 72.8 | 454 | 4.0 |
| CLOISITE ® 10A | | | |
| P(S-co-EMA) + 1 wt % | 72.7 | 450 | 0.9 |
| CLOISITE ® 15A | | | |
| P(S-co-EMA) + 3 wt % | 78.2 | 452 | 2.4 |
| CLOISITE ® 15A | | | |
| P(S-co-EMA) + 5 wt % | 77.6 | 457 | 4.0 |
| CLOISITE ® 15A | | | |

The thermal degradation of the different types of CLOISITE® were also studied, and the TGA curves are shown in FIG. 10. As shown, CLOISITE® Na⁺ without the organic modifier is very slightly degraded (less than 3%), even at 500° C. All of the organo-modified types of CLOISITE® present some thermal degradation, starting at approximately 220° C. until almost 380° C. The mass loss is almost 28% and 26% for the CLOISITE® 15A and 10A, respectively. However, since the amount of OMMT used in the formation of the nanocomposites was very low (i.e., 1 wt % in most experiments and up to 5 wt %), the degradation of the nanofiller itself is not expected to affect the values of the nanocomposites' mass loses by more than 0.28-1.4%.

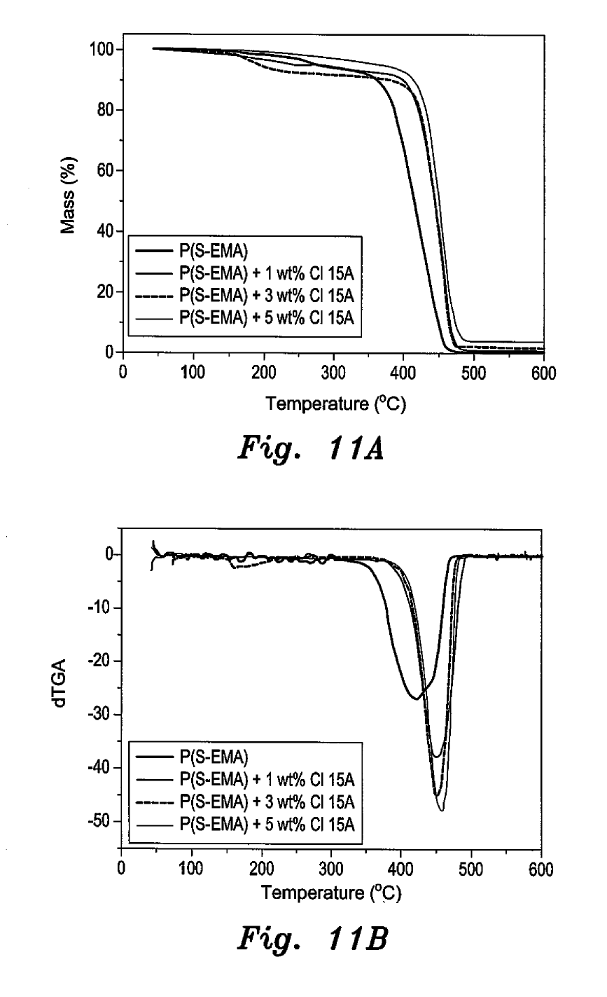

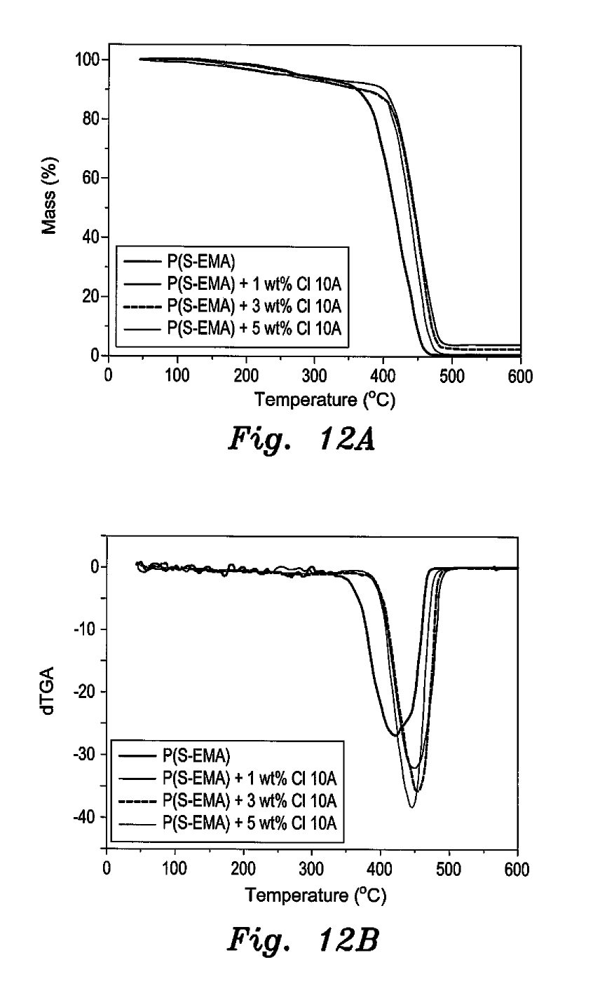

FIGS. 11A and 11B show the curves for the TGA measurements used to determine the mass loss (FIG. 11A) or the differential mass loss (FIG. 11B) to thermal degradation of the pristine P(S-EMA) nanocomposites with CLOISITE® 15A, Similarly, FIGS. 12A and 12B show the curves for the TGA measurements used to determine the mass loss (FIG. 12A) or the differential mass loss (FIG. 12B) to thermal degradation of the pristine P(S-EMA) nanocomposites with CLOISITE® 10A. As can be clearly seen, the thermal stability of the P(S-EMA)/MMT nanocomposites improves when compared to the pure copolymer (seen as the shifting of the degradation curve to higher temperatures). The origin of this increase in the decomposition temperatures may be attributed to the ability of nanometer silicate layers to obstruct volatile gas produced by thermal decomposition. Accordingly, thermal decomposition begins from the surface of the nanocomposites, leading to an increase of the organo-MMT content and the formation of a protection layer by the clay.

In terms of the OMMT type, it appears that both nano-fillers show almost the same protection to thermal degradation of the material formed. The residual mass of all nanocomposites is in accordance with the amount of OMMT initially loaded (as seen above in Table 3). Further, from the DTGA curves, single peaks are observed in all nanocomposites and the pristine copolymer. This is an indication that degradation mechanism is taking place mainly in one step, both for the pristine copolymer and all nanocomposites, indicating the formation of macromolecular chains without defects in their structure. Thermal stability did not significantly change when the amount of CLOISITE® was increased.

It is to be understood that the present invention is not limited to the embodiments described above, but encompasses any and all embodiments within the scope of the following claims.

We claim:

1. A polymer-clay nanocomposite, comprising poly(styrene-co-ethyl methacrylate) copolymer having nanoparticles of an organo-modified clay filler dispersed in the copolymer.

2. The polymer-clay nanocomposite according to claim 1, wherein the organo-modified clay filler comprises montmorillonite modified with a quaternary ammonium salt.

3. The polymer-clay nanocomposite according to claim 1, wherein the quaternary ammonium salt comprises a dimethyl, benzyl, hydrogenated tallow quaternary ammonium salt.

4. The polymer-clay nanocomposite according to claim 1, wherein the quaternary ammonium salt comprises a dimethyl, dihydrogenated tallow quaternary ammonium salt.

5. The polymer-clay nanocomposite according to claim 1, wherein the organically modified clay filler forms between 1.0 wt % and 5.0 wt % of the nanocomposite.

6. A method of making a polymer-clay nanocomposite material by in situ polymerization, comprising the steps of:
dispersing nanoparticles of an organo-montmorillonite clay in a mixture of styrene and ethyl methacrylate monomers in a styrene to ethyl methacrylate ratio of about 1:1, the organo-montmorillonite clay being between 1.0 wt % and 5.0 wt % of the combined mixture;
adding a free radical initiator to the mixture; and
heating the mixture to about 80° C.

7. The method of making a polymer-clay nanocomposite material as recited in claim 6, wherein the organo-montmorillonite clay comprises montmorillonite modified with a quaternary ammonium salt.

8. The method of making a polymer-clay nanocomposite material as recited in claim 6, wherein the step of dispersing the organo-montmorillonite clay in the styrene and ethyl methacrylate mixture comprises magnetic and ultrasonic agitation.

9. The method of making a polymer-clay nanocomposite material as recited in claim 6, wherein the free radical initiator comprises benzoyl peroxide.

10. The method of making a polymer-clay nanocomposite material as recited in claim 6, wherein the organo-montmorillonite clay comprises montmorillonite modified with a dimethyl, benzyl, hydrogenated tallow quaternary ammonium salt.

11. The method of making a polymer-clay nanocomposite material as recited in claim 6, wherein the organo-montmorillonite clay comprises montmorillonite modified with a dimethyl, dihydrogenated tallow quaternary ammonium salt.

12. A polymer-clay nanocomposite material made by the process of claim 6.

13. A method of making a polymer-clay nanocomposite material, comprising the steps of:
dispersing nanoparticles of an organo-montmorillonite clay in a mixture of styrene and ethyl methacrylate monomers, the organo-montmorillonite clay being between 1.0 wt % and 5.0 wt % of the combined mixture;
adding a free radical initiator to the mixture; and
heating the mixture to about 80° C. to copolymerize the monomers.

14. The method of making a polymer-clay nanocomposite material as recited in claim 13, wherein the organo-montmorillonite clay comprises montmorillonite modified with a dimethyl, benzyl, hydrogenated tallow quaternary ammonium salt.

15. The method of making a polymer-clay nanocomposite material as recited in claim 13, wherein the organo-montmorillonite clay comprises montmorillonite modified with a dimethyl, dihydrogenated tallow quaternary ammonium salt.

16. The method of making a polymer-clay nanocomposite material as recited in claim 13, wherein the mixture of styrene and ethyl methacrylate monomers comprises a styrene to ethyl methacrylate ratio of about 1:1.

17. The method of making a polymer-clay nanocomposite material as recited in claim 13, wherein the step of adding a free radical initiator to the mixture comprises adding benzoyl peroxide to the mixture.
